(19) United States
(12) Patent Application Publication
(10) Pub. No.: US 2008/0155216 A1
(43) Pub. Date: Jun. 26, 2008

(54) Protection and Recovery System for Automatic Disk Recovery

(76) Inventor: Dov Shoham, Hemed (IL)

Correspondence Address: SOROKER-AGMON ADVOCATE AND PATENT ATTORNEYS, NOLTON HOUSE, 14 SHENKAR STREET, HERZELIYA PITUACH, 46725, omitted

(21) Appl. No.: 11/816,441

(22) PCT Filed: Aug. 2, 2005
(86) PCT No.: PCT/IL05/00825

§ 371 Date: Aug. 16, 2007

(30) Foreign Application Priority Data
Feb. 17, 2005 (IL) PCT/IL2005/000205
Aug. 2, 2005 (IL) PCT/IL2005/000825

(51) Int. Cl. G06F 15/177; G06F 12/16

(52) U.S. Cl. 711/162; 713/2; 711/E12.008; 711/E12.103

(57) ABSTRACT

A disk drive protection or recovery system permits recovery even if the operating system (e.g., MS-Windows, etc.) has crashed, failed, or been disabled or tampered with. If the recovery hardware is not found, the operating system cannot be loaded and the computer is disabled. The invention creates multiple recovery points and automatically selects a preferred point for recovery operations or sequentially applies restoration/back-up points in time order.

### FIELD OF THE INVENTION

The present invention relates generally to computer hardware and software and more particularly to hardware-based recovery systems for disk drives for personal computers.

### BACKGROUND OF THE INVENTION

Significant time is lost by home users and small business alike in recovery operations due to user error, viruses, malfunctions or other failures. Back-up operations are onerous as well and most home and small business users do not have back-up procedures in place as does a large enterprise, which typically might perform a full system back-up weekly and incremental system back-up daily. In this manner, should there be a system crash, an administrator or operator applies the appropriate back-ups after the fault/failure has been corrected. Thus, all but the most recent (since the last incremental back-up) data is restored.

Home users and small businesses often have no back-up procedures in place. It is often necessary to rebuild a HDD and then restore the contents. This is an onerous task and may take the better part of a work day leaving no time to get the real work of the business or home user done.

A number of proposals and products have been developed in this area. One such device is described by Gonen Ravid in U.S. Patent Application Publication No. 2002/0133747A1 filed Mar. 13, 2001, hereinafter “Ravid”. Ravid describes a hardware-based recovery system. The Ravid system employs both working and back-up hard disk drives and, in particular, the HDD protection and recovery apparatus (controller board) 10 of Ravid is plugged in between the computer and a HDD of the system. When there is a failure of the working HDD, the back-up HDD can be put into use via an A-B system. According to the Ravid application, the back-up HDD can be accessed selectively and/or incrementally.

Other proposals and products are on the market but both the software and hardware instant recovery solutions have drawbacks. In conventional hardware computer recovery systems, when a personal computer has a failure, the computer can only return to a single previous state (e.g., the master disk hard image) and require positive user intervention for the back-up process. Software solutions can be easily bypassed and/or disabled. Prior art hardware solutions work only after the installation of an operating system, such as MS-Windows.

### SUMMARY OF THE INVENTION

The disclosed invention describes a method and apparatus for the protection or recovery of one or more disk drives of a computing platform or one or more partitions of the computing platform or one or more parts of the computing platform, the apparatus comprising: one or more storage areas, each storage area is capable of storing data for one or more recovery points for the disk drive or partition of the computing platform or the part of the computing platform; and a backup software for generating one or more recovery points for the one or more disk drives or for the partition of the disk drive or for the part of the disk drive. The apparatus can further comprise recovery software for recovering the one or more disk drives or the one or more partitions of the disk drive or the one or more parts of the disk drive to a state presented by a predetermined recovery point. Within the apparatus, each storage area comprises one or more master image back-up storage areas for storing a baseline recovery image. The apparatus can further comprise a temporary data storage area. Within the apparatus, each recovery point can be associated with one or more of the group consisting of: a name; a description; a time; or a date. The number and size of said recovery points are limited by available disk drive space. The apparatus can further comprise a problem detecting module for verifying the existence and functionality of one or more entities, said entity belongs to the group consisting of: a device; a service; a program; or a parameter. The apparatus can further comprise a controller for initiating a disk drive recovery operation using a predetermined recovery point. The apparatus can further comprise a device communicating with a disk drive via a communication path, the communication path can be a personal computer interface bus.

Another aspect of the invention relates to a computer readable storage medium containing a set of instructions for a general purpose computer, the set of instructions comprising: a backup component for generating one or more recovery points for one or more disk drives or one or more partitions of the disk drive or one or more parts of the disk drive. The computer readable storage medium can farther comprise a recovery component for recovering one or more disk drives or one or more partitions of the disk drive or one or more parts of the disk drive to a state presented by a predetermined recovery point.

Yet another aspect of the invention relates to an apparatus for disk drive protection and recovery comprising: a device module communicating bi-directionally with a disk drive of a computing platform via a communication path; and a component for operating said hard disk drive protection and recovery apparatus. Said communication path can be a personal computer interface bus. The apparatus can further comprise a driver module in direct bi-directional communication with said device module. The driver module can include an identification verification module. The apparatus can further comprise: one or more storage areas, for storing data for one or more recovery points for the disk drive; and a backup component for generating an at least one recovery point for an at least one disk drive or an at least one partition of the at least one disk drive or an at least one part of the at least one disk drive. The apparatus can further comprise a recovery component for recovering the disk drive or the partition of the disk drive or the part of the disk drive to a state presented by a predetermined recovery point. Within the apparatus the recovery component can loaded to the memory of the computing platform during a boot operation. Within the apparatus the device module can further comprise a buffer; a communication interface; a programmable device identifier, the programmable device identifier being in communications with the buffer; and flash memory, the flash memory in communications with the buffer, the buffer forwarding data to the communication interface, said communication interface in bidirectional communications with the disk drive. The communication interface can be a bus interface. Within the apparatus the device module can be of the following group: universal serial bus device; a personal computer interface device; a mobile phone; a disk on key; an authentication device; a flash read-only-memory; a disk on module.

Yet another aspect of the invention relates to an apparatus for disk drive protection and recovery comprising: a device module communicating with a disk drive via a bus; a component for operating said disk drive protection and recovery apparatus; one or more storage areas, for storing data for one or more recovery point for the disk drive; and a backup component for generating one or more recovery points for the disk drive or one or more partitions of the disk drive one or more parts of the disk drive. The apparatus can further comprise a recovery component for recovering the one or more disk drive or the at least one part of the disk drive or the at least one partition of the disk drives to a state at which a predetermined recovery point was generated.

Yet another aspect of the disclosed invention relates to a method for protection and recovery of a disk drive of a computing device, the method comprising the steps of: initiating a boot sequence on said computing device; verifying a protection or recovery apparatus is properly installed on said computing device; and preventing further booting operations until an electronic identification key is introduced to said computing device.

Yet another aspect of the disclosed invention relates to a method for protection and recovery of one or more hard disk drives of a computing device, the method comprising the steps of: storing one or more recovery points for the hard disk drive; and restoring the hard disk drive from the stored recovery point. Within the method, the stored recovery point can be overwritten and stored again. Within the method, the stored recovery point is kept after the hard disk drive was restored, or the recovery point is destroyed after the hard disk drive was restored to the recovery point. Within the method, one or more additional recovery points which were stored after the recovery point, are possibly destroyed after the hard disk drive was restored to the recovery point. The method can further comprise the steps of: detecting one or more problems with the existence and functionality of one or more entities of the following group: a device; a service; a program, a parameter; and activating the restoring step if a problem is detected in the entity. Within the method, the storing and restoring steps are performed separately by a user or by an administrator.

The last aspect of the present invention relates to a method for protection or recovery of a disk drive of a computing device, the method comprising the steps of: booting said computing device; verifying a protection or recovery apparatus is properly installed; preventing further booting operations until an electronic identification key is introduced to said computing device; storing one or more recovery points for the disk drive; and restoring the disk drive from the one or more stored recovery points.

### BRIEF DESCRIPTION OF THE DRAWINGS

The above and other features and advantages of the invention will be more readily understood from the following detailed description of the invention, which is provided in connection with the accompanying drawings:

FIG. 1 shows a computer system, including a personal computer (PC), constructed in accordance with a preferred embodiment of the present invention;

FIG. 2 is a schematic view of a portion of the system of FIG. 1;

FIG. 3 shows another computer system, including a laptop or notebook computer, constructed in accordance with another preferred embodiment of the present invention;

FIG. 4 shows another computing system, including a handheld computing device such as a Palm or personal digital assistant (PDA), constructed in accordance with another preferred embodiment of the present invention;

FIG. 5 is a schematic view of a portion of the system of FIG. 1, showing a hardware configuration;

FIG. 6 is a flowchart illustrating the operation of a recovery system in accordance with the preferred embodiments of the present invention; and

FIG. 7 is a flowchart illustrating recovery from a system crash in accordance with the present invention.

### DETAILED DESCREPTION OF PREFFERRED EMBODIMENTS

The disclosed invention describes a method and apparatus for protecting a disk drive of a computing device or a partition thereof from failures or attacks, and providing a mechanism for restoring the hard disk to a pre-stored state. The apparatus preferably further comprises a component for storing and retrieving one or more recovery points the user might want to restore at a later time. The apparatus stores the file allocation table at the time of the backup, and disables overwriting the protected files, so that the file allocation table remains valid. The apparatus preferably comprises a component for detecting problems with the computing device, services, parameters or components thereof. Preferably, the apparatus comprises also a device connecting to the personal computer interface bus, which is used for identifying the user of the computer and prevents booting the machine when the device is not available, or when used by an unauthorized user. The present invention is described and shown in connection with an exemplary embodiment relating to hardware-based disk drives preferably for personal computers. Persons skilled in the art will appreciate that the present invention can be applied to any disk drive, whether fixed or detachable, local or remote, and is generally a device that reads or writes to and from a disk, which is generally an object having magnetic material used for storing data thereon.

The present invention relates and claims priority from PCT patent application serial number PCT/IL2005/000205 titled PROTECTION AND RECOVERY SYSTEM FOR AUTOMATIC HARD DISK DRIVE (HDD) RECOVERY, filed 17 February 2005, the content of which is hereby incorporated by reference.

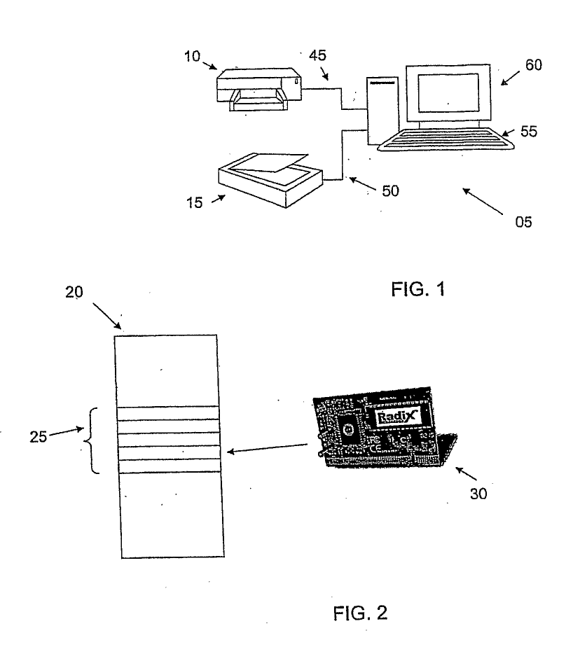

Referring now to the drawings, where like reference numerals designate like elements, there is shown in FIG. 1 an exemplary embodiment of the present invention showing a PC system 05 constructed in accordance with a preferred embodiment of the present invention. The PC system 05 has a plurality of peripherals such as printer 10 and scanner 15. Printer 10 is connected to PC 05 via a connection cable 45. Scanner 15 is also connected to PC 05 via a connecting cable 50. The PC 05 has a keyboard 55 and a monitor 60. PC 05 also has a HDD (not shown in FIG. 1) and any combination or all of the following peripheral devices: a modem, a mouse, multimedia devices including for example a digital camera, a zip drive (not shown) or other peripherals available for a PC system. PC 05 is shown having a tower 20 (see FIGS. 1 and 2), which house components and cards/boards (e.g. mother board, graphics board, math accelerator board, etc.) PC 05 may be any brand or type of PC including SUN, MAC, eMAC, powerMAC. PC 05 is not limited as to use and may be used for any purpose including as small server, network server, etc.

As shown in FIG. 2, the tower 20 has slots into which are plugged cards or boards. The slots may be personal computer interface (PCI) slots or universal serial bus (USB) slots and the card/boards, which are plugged into the slots, are correspondingly PCI-cards/boards or USB-cards/boards, or any like or other communication path. In an alternative embodiment, the PC 05 may have horizontal unit to house its components and cards/boards. The illustrated HDD protection and recovery card 30 is one such device that is plugged into one of the available (unused) slot 25 of tower 20 depending on the recovery system option (PCI or USB) selected. The protection and recovery system has two alternative embodiments when used with PCs 05—as a PCI-card/board for use in slot 25 or a USB-card/board for use in slot 25. The underlying circuitry may be essentially the same even where the interface is different.

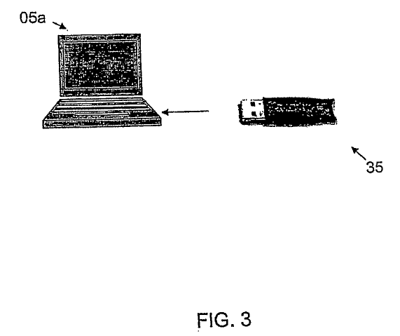

FIG. 3 is an alternative preferred embodiment of the present invention use with laptop or notebook computer. In this embodiment HDD protection and recovery device 35 replaces HDD protection and recovery card 30. The protection and recovery device 35 plugs into USB port of the laptop o notebook computer. The HDD protection and recovery system of the present invention includes a HDD protection and recovery card/board or a HDD protection and recovery device and software installed and configured to operate the HDD recovery and protection card or device by creating at least one recovery point and permitting the recovery of the HDD from the at least one recovery point.

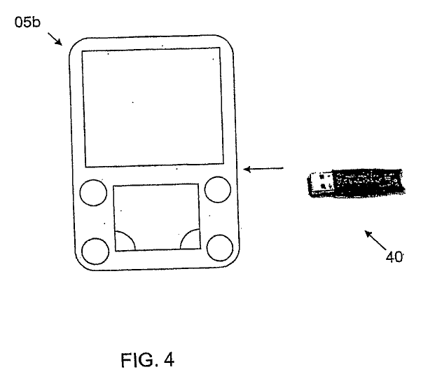

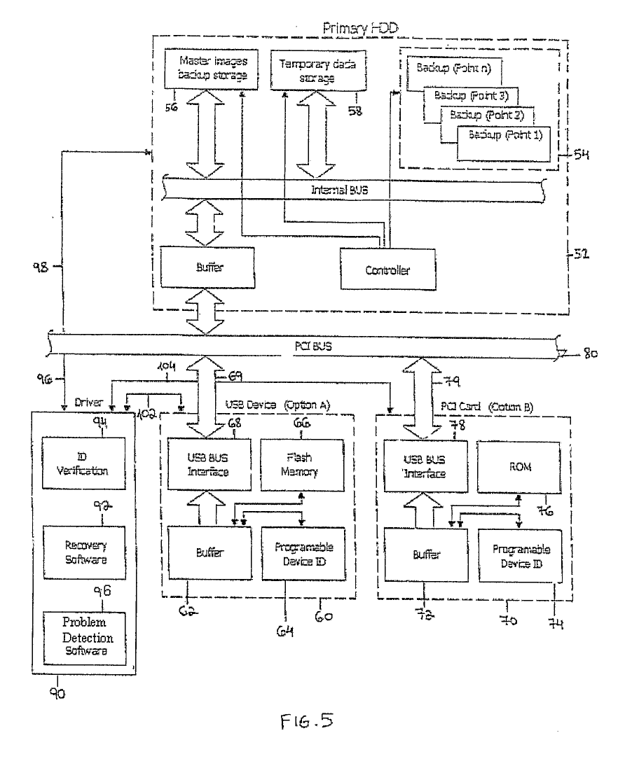

FIG. 4 is an exemplary embodiment of a micro-HDD protection and recovery device 40 used for micro-HDD protection and recovery for a handheld computing device such as a PDA or PALM 05b. The micro-HDD protection and recovery device is attached operationally to the handheld computing device via an expansion slot or expansion box having a USB port. A micro-hard disk drive is smaller in size but operates similarly to a hard disk drive and all references herein to a hard disk drive include a micro-hard disk drive, in particular, when used with a handheld computing device. The use of the term HDD below is intended to include micro-HDD, flash-HDD and any other HDDs for use in any kind/type of laptops, notebook computers, PCs and handheld computing devices. It is also noted that the protection and recovery device may be used in any embedded computing device such as are operable in cars, home appliances, such as TV sets, etc. The hardware interface for embedded computing devices may be different and the external appearance of the device may also be different but the underlying logic circuitry is the same.

Users of home and small business PCs produce data via emails, documents, (spreadsheets, text documents and graphics), Internet downloads, etc. Users also frequently add new applications to their PC systems or upgrade applications already running on their PC systems. Using the HDD protection and recovery system, the user can configure the system with multiple recovery points and can thereby instantly restore their computers or partitions thereof to any previously preset recovery point without any further or additional technical assistance.

The HDD protection and recovery system of the present invention uses both hardware and software. The hardware is in the form of protection and recovery logic circuitry (a card for PCs and a device for laptops, notebook computers and handheld computing devices). The logic circuitry will be referred to as an apparatus hereinafter to include either a card or a device. The software is installed on the PC and executed at least each time the system is booted. Either or both of these illustrative embodiments or the combination may be implemented in hardware, in software, in firmware, as Application Specific Integrated Circuits (ASICs) or Field Programmable Gate Arrays (FPGAs) or any combination thereof.

FIG. 5 is a schematic block diagram showing an exemplary embodiment of the main components of the HDD protection and recovery apparatus. The HDD protection recovery apparatus physically resides on a card which is plugged into an available slot coupled to the PCI bus of a PC. When the HDD protection recovery apparatus is used with PCs, there are two alternate embodiments. Both embodiments comprise cards that are inserted into free slots coupled to the PCI bus of a PC. The logic is preferably essentially the same for both embodiments. The interface may be different depending on whether the user selects a USB interface or a PCI interface. For use with a laptop, a notebook computer or handheld computing device such as a PDA or PALM, the protection and recovery apparatus is a device that plugs into a USB port. USB device module 60 of the HDD protection and recovery apparatus using a USB port is denominated Option A in FIG. 5 and the PCI device module 70 of the HDD protection and recovery apparatus using a PCI port is denominated Option B in FIG. 5. Since the logic circuitry is essentially the same, only Option A will be described. Option B operates similarly. The HDD protection and recovery apparatus includes driver module 90, and one of USB device module (Option A) or PCI device module (Option B). The HDD protection and recovery apparatus also interfaces with the HDD in which are stored snapshots of the HDD at user-specified recovery points. The HDD is partitioned. Only the components of the HDD which are affected by or used by the protection and recovery system are described. According to option A, the HDD protection and recovery apparatus is plugged into an available USB slot. USB device module 60 of the HDD protection and recovery apparatus interfaces bi-directionally with PCI bus 80 of a PC via an interface 69. Information and control commands are exchanged between bus interface 68 and interface 69. It will be appreciated by persons skilled in the art that other devices can be used instead of USB device 60 or PCI device 70, such as but not limited to disk on key, Smart Cards, tokens, such as authentication devices, PKI, or the like, flash ROM devices, DOM (disk on module), mobile phones and smart phones, and other devices with or without bootable capabilities. Driver module 90, residing on the flash memory of USB device 60, or on the ROM of PCI device 70, is loaded to the memory of the computer once the device is located. Driver module 90 includes an ID verification module 94, a recovery module 92, and a problem detection component 96. Problem detection component 96 comprises one or more feed back and detection systems, modules, functions or other components, each intended to regularly verify the existence or functioning of a specific device, service, parameter, or any other entity that should be monitored. Such monitored entities include for example disks, external connections, files, drivers, spyware, a change in the operating system and the like, tracked by watch dog programs, remote monitoring system or other methods. Once a problem with any such device, program, service, parameter or the like is detected, the system can deduce the existence of a problem, such as a crash, a virus, system performance deterioration, a problem caused by an installation, or the like and can initiate a restore operation, with or without getting the user's confirmation, according to the installation configuration. Driver module 90 interfaces directly with USB device module 60 via interface 102. That is, information and control signals do not use the PCI bus of the PC system 05. Buffer 62 forwards data to bus interface 68 in response to control signals from driver module 90 that have been forwarded to flash memory 66 and stored therein. The programmable device identifier (ID) is stored in programmable device ID module 64 and is used in conjunction with the ID verification module of driver module 90. The HDD stores a one or more master images for back-up in Master Images Backup Storage 56. The master images (or images) are baseline recovery images also called recovery “Point 0”, or other distinguishing names. These master images are preferably created by the computer system manager, as possible base lines of the disk or a partition thereof. The manager might be a system administrator or the owner/operator of a home PC system 05, e.g., a parent. Additional back-up/recovery/restoration points can be added and identified with a name and a textual description. In addition to the name and description, the protection and recovery system stores the date and time of the snapshot. The additional back-up points are stored in one or more partitions of HDD 54 and are used in the recovery process. Each backup point, “point 0” and other baseline points included, comprises the file allocation table and the partition table as of the backup time. When the HDD protection and recovery system is active, files in the protected partition are not overwritten at their current location, but rather copied elsewhere, and the file allocation table is changed accordingly. In addition, the area on which a file is written is marked by the system as non-usable, so the area will not get overwritten. Thus, when restoring from an older file allocation table, which was stored during a backup, a pointer to a file will indeed point at a location on the disk containing the file as was when the backup took place. Data may also be stored temporarily in Temporary Data Storage 58, which is used for restoration with the software portion of the HDD protection and recovery system. Temporary Data Storage 58 stores incremental data reflecting changes that occurred in the protected disk or partition thereof since the last backup was stored. Temporary Data Storage 58 can be a monolithic file, a fragmented file, and can even reside on an external device such as USB device 60, and not necessarily on the protected disk or partition thereof. Therefore, it is not limited in size and can be as large as required, and contain reference to all required files. While the devices attached to a laptop or notebook computer or handheld computing device appear physically different, the logic contained therein is essentially the same and operates in accordance with the description of FIG. 5 above. PC system 05 may have at least 4 GB HDD and at least 500 MB free disk space.

Prior to installing the hardware portion of the HDD protection and recovery system, the HDD should be configured to have a single primary boot partition. If a second primary partition exists it should be converted to an extended partition using an HDD partitioning utility. That is, the primary HDD partition is the protected partition. Any anti-virus software and any virus protection in BIOS are preferably disabled prior to installation of the HDD protection and recovery apparatus. After turning off the power to the PC and removing its cover, the protection and recovery apparatus is inserted into a free slot. Once the card is properly seated, then the cover is put back on the tower and the power is turned back on. Once the PC is running, execution of MS Windows in an appropriate version is initiated. In the case of laptop/notebook computers and handheld computing devices, installation of an HDD protection and recovery device 35, 40 is via a USB port and does not require the removal of the cover for installation. Once MS Windows is verified to be properly running, the HDD protection and recovery software is installed and configured. Configuration includes setting the manager's password and the user's name and password. The manager's password may be saved to a floppy disk. Further, configuration of the software portion of the HDD protection and recovery system includes the option to enable or disable features such as a user's name and password, restore and save. During system configuration, it is also possible to select from a plurality of “Boot Options”. That is, upon booting or rebooting the PC, the HDD may be restored, new back-up points may be added, work can be continued within the current partition or the partition saved. Specifically, selecting “Keep” during system configuration will not restore the system from a restoration point but rather will keep using the current partition from the last session. Selecting the “Add Point” option during system configuration will add a new restore/back-up point by taking a snapshot of the current status of the protected partition. The number of restoration points is limited only by available HDD space. Selecting the “Restore” option during system configuration means that upon booting or rebooting the PC, the protected partition is restored to the last saved restore point or to the recovery “Point 0” created by the manager. The “Save” option is preferably enabled to the system manager only and is password protected. Selecting the “Save” option means that the current status of the protected partition will be permanently saved. That is, the current status (snapshot) of the protected partition will be saved as the new “Point 0” and all prior existing restoration/back-up points will be erased. During configuration it is also possible to add new restoration/back-up points. Back-up points may be desirable, for example, immediately prior to installation of new software, after a database update or associated with any other event. Back-up points may also be set daily, weekly, bi-weekly or monthly. During configuration of the system, a specific restoration/back-up point is selected. If only “Point 0” is available, the HDD will automatically be restored to “Point 0”. If multiple restoration points have been defined and stored, any of the points may be selected. In order to prevent data loss in case of a power failure during Multi-Point Restoration, the HDD protection and recovery system will perform a sequential restoration, point after point. That is, the system will be restored to the last point, and then the previous restoration point in time will be applied until all back-up points have been applied until the required point. Should a power failure occur during restoration, the restoration process will halt, the specific restored point and all consequent points will be lost, and all un-restored points (from “point 0” to the last non-restored point) will remain intact.

During configuration, it is possible to select automatic saving and HDD restoration. One option for accomplishing automatic saving and HDD restoration is to display a menu upon each boot/reboot for the user to select a restoration point. Another option is to have the HDD protection and recovery system save a new back-up point at every boot, occurring before or after a fixed time interval (daily, weekly, monthly, etc.), i.e., the HDD protection and recovery system will add a new restoration point at the next boot, provided that the system was working for a period of time longer than the specified fixed time interval. Another option is to configure the HDD to recover the protected partition to point 0 during every system boot. A further option is to select scheduled HDD restoration to point 0 at fixed time intervals. Yet another option is to keep the last status of a protected partition even if the PC system is rebooted.

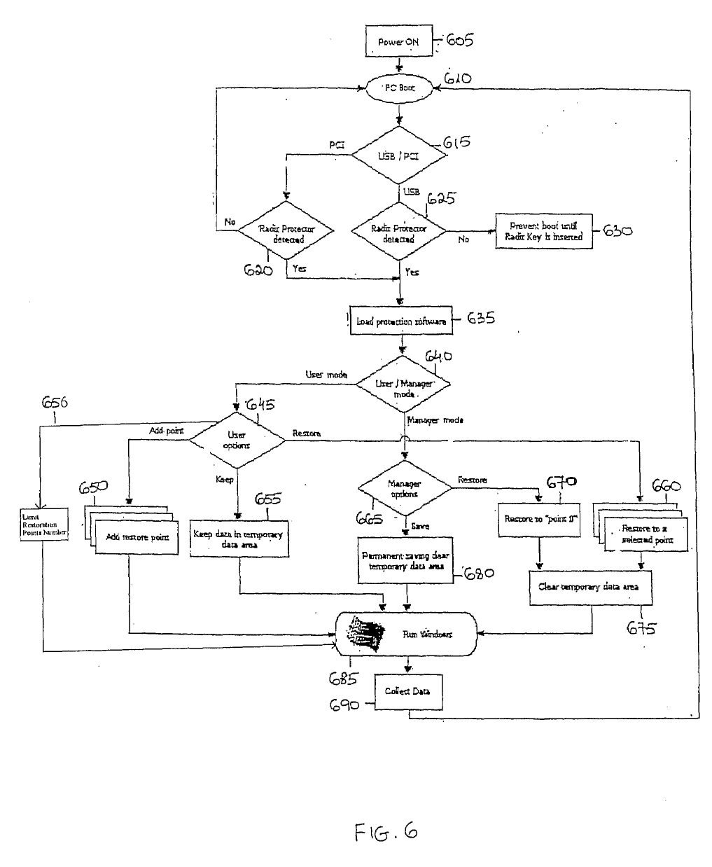

FIG. 6 is a flowchart showing an exemplary embodiment of the operation of the recovery portion (software) 600 of the HDD protection and recovery system. The PC is powered on by a user at step 605 and the PC is booted at step 610. A check is made upon booting, and prior to the initiation of the operating system, for the HDD protection and recovery apparatus at step 615. A subsequent check is made to determine if the HDD protection and recovery apparatus has a PCI module at step 620 or a USB module at step 625. Alternatively, the check for the PCI device performed at step 620 can be performed only prior to changes in the system, i.e. restorations, such as prior to user steps 660 (restoring to a selected point) or 670 (restoring to “point 0”), or prior to manager step 680 (manager storing) discussed below.

If neither is present, or neither is detected due to improper installation, the system will be prevented from booting at step 630 until a personal electronic key is inserted. The boot prevention is enabled since the recovery software replaces the contents of sector 0 of the HDD. Therefore, Windows or another operating system will not start until the recovery software issues an appropriate command. The command will be issued only after the software finished executing the commands associated with storage or retrieval, for example the retrieval commands as provided by the user through the user interface. Once the recovery software has finished executing, it starts Windows or the operating system. More specifically, when the BIOS is loaded to the computer memory, the boot order is loaded as well, and normally the boot is performed according to the order as set in the BIOS, or according to the default BIOS settings. Every approached device checks for the availability of a boot record, and if a boot record is found on the device, the device performs a “hand raising”, i.e., issues a notification. Since the HDD protection program loads in the memory block as a hardware ROM device right after the BIOS, prior to any other I/O device, the boot order is changed by diverting to the boot record on the HDD, and preventing the “hand raising” of additional devices such as CD-ROM. The prevention is executed by starting a program which monitors interrupt 19, which controls the I/O of the devices, thus preventing the computer to continue booting from a disk, if the device or the key is not present.

Once it is verified that the HDD protection and recovery apparatus is installed and that the ID is proper, the recovery software stored in recovery software module 92 is loaded to the memory at step 635, which is performed during the boot operation and prior to the initiation of the operating system. A menu appears and the user is prompted to select whether the system is to be activated in user or manager mode at step 640. If user mode is selected then the user is prompted to select at step 645 from among the following options: adding a backup point, keeping the current status, limiting the number of stored points, or restoring the system to an earlier backup. If the user selects adding a point, then a new restore/back-up point will be added at step 650, from temporary data storage 58. If the user selects keeping the current status, then the data is kept in the temporary data storage area 58 at step 655. At step 656, the user is provided with the possibility to limit the number of stored restoration points to a specific number. When this option is used, the addition of a new restoration point causes the deletion of the earliest one. This option is alternatively given also to a manager, although it is less required there, because a manager is likely to store only a few points, such as “company restoration point” and “department restoration point”.

If the user selects restoration, then the user is prompted to select a restoration point from a set of restoration points at step 660. If the user selects to restore the system to the last saved point, the temporary data storage 58 is discarded, and the file allocation table points to the last saved backup point

If the user selects another restoration point, for example a point the user stored when the system was at a desired stage which the user suspected he would like to restore, then the specific point is restored. The restoration process comprises restoring the last available point, and all the previous ones, until the desired point. For example, if there are 10 restoration points, and the user wishes to restore point 8, the system restores point 10, point 9 and point 8. The user can declare each restoration point as “fixed” or “temporary”. When restoring to a “temporary” point, the point itself and all its subsequent points will be deleted once the system is restored. When restoring to a “fixed” point, the point will not be destroyed, so that it will be possible to restore to that point again anytime in the future. This will enable the user to define one or more “configurations” he might want to alternately restore to and use. For example, consider a user working on multiple projects, each project requiring a different configuration. The user can define a fixed restoration point for each project, and whenever he switches from project A to project B, he optionally starts by overwriting the current configuration of project A to preserve the changes occurred since the last storing of project A configuration, and then restores the configuration relevant for project B. If the user did not store an updated point for project A, the previously stored point is still valid and the user can restore from it the next time he wants to work on project A. Thus, when returning to project A, restoring the relevant configuration will put the user's computer back in the state it was when the user last stored the configuration associated with project A. If the user selects manager mode at step 640, then the manager is given the option of restoring the HDD or saving the HDD at step 665. If the manager selects the restore option, then the HDD is restored to “Point 0” or any other of the baseline restoration point, according to the manager's selection at step 670. Upon the completion of either step 660 or 670 the temporary data is cleared from the temporary data storage area at step 675. If the manager selects the save option, then the data stored in the temporary data storage area 58 is permanently saved as a new point 0 and the temporary data storage area 58 is cleared at step 680. Upon the completion of any of steps 650, 655, 675 or 680, the operating system is initiated at step 685, by calling the Windows boot process, or any other device according to the boot order. The boot then continues from the device with the HDD protection still in the background. We can also exclude devices set in the BIOS as boot devices and remove them from the boot order). Devices set in the BIOS as boot devices can be excluded and removed from the boot order.

Data related to the current status of the file system of the protected disk or partition thereof such as new hardware or software installation, user's personal configurations settings, and new files produced by the user, is collected in accordance with the configuration of the HDD protection and recovery system at step 690 and stored in buffer 62 or 72 of FIG. 5. The same flow, starting at step 640 occurs when the user initiates a backup/restore operation, or when the system detects a problem and initiates the operation. The system may detect a crash or another problem in multiple hardware or software components of the protected system. The detection is performed by problem detection component 96, detailed in association with FIG. 5 above.

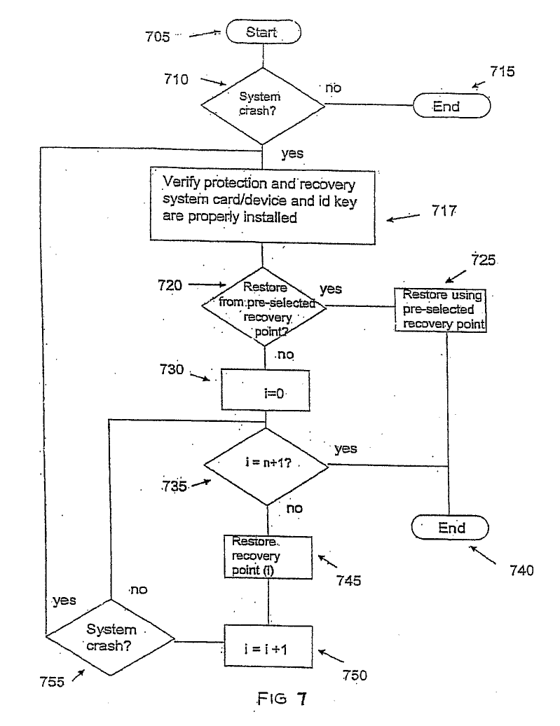

FIG. 7 is a flowchart illustrating an exemplary embodiment of the HDD recovery from a system crash. The recovery portion of the HDD protection and recovery system starts at step 705. Step 710 is a query to determine if there has, in fact, been a HDD crash. If there has not been a HDD crash, then the recovery process ends at step 715. Verification is performed to ensure that a HDD protection and recovery apparatus and an id key are properly installed and valid at step 717. Since there are two different recovery options that were pre-selected during configuration, at step 720 it is determined whether the pre-selected recovery process is recovery from a pre-selected recovery point. If this option was selected, then the HDD is restored from the pre-selected recovery point at step 725. The option then ends at step 740. If the option to use a pre-selected recovery point was not selected at system configuration, then HDD recovery is performed by sequentially applying all available recovery points in time order. A counter “i” is initialized to 0 at step 730. The counter is checked to make sure it has not been incremented to exceed the number of recovery points “n” by checking the counter against “n+1” at step 735. If all of the recovery points have been applied, then the recovery process ends at step 740. If all recovery points have not as yet been applied, then the next recovery point is applied at step 745. The counter is then incremented at step 750. If there is a HDD crash while applying the recovery points sequentially, as determined at step 755, then the recovery process attempts to start over again at step 717. If there has been no HDD crash, then the recovery points continue to be applied until the recovery process is complete. In actuality, step 755 could be performed at anytime after step 720 or between any steps thereafter or viewed as an interrupt to restart the recovery process. The HDD protection and recovery system of the present invention may be arranged for use on laptop computers, notebook computers and handheld computing devices. Handheld computing devices typically use the PALM OS operating system.

The disclosed invention provides protection against unlawful users of a computing device, detection of problems and a restoration mechanism for restoring to a previous state if a problem occurred, or according to the user's request. While the invention has been described and illustrated with reference to specific exemplary embodiments, it should be understood that many modifications and substitutions can be made without departing from the spirit and scope of the invention. Although the embodiments discussed above describe specific hardware, software, operating systems, the present invention is not so limited. Accordingly, the invention is not to be considered as limited by the foregoing description but is only limited by the scope of the claims which follow.

What is claimed is:

1. An apparatus for the protection or recovery of an at least one disk drive of a computing platform or an at least one partition of the computing platform or an at least one part of the computing platform, said apparatus comprising:
an at least one storage area, each storage area is capable of storing data for at least one recovery point for the at least one disk drive or the at least one partition of the computing platform or the at least one part of the computing platform; and
a backup software for generating an at least one recovery point for the at least one disk drive or for the at least one partition of the at least one disk drive or for the at least one part of the at least one disk drive.

2. The apparatus according to claim 1 further comprising recovery software for recovering the at least one disk drive or the at least one partition of the at least one disk drive or the at least one part of the at least one disk drive to a state presented by a predetermined recovery point.

3. The apparatus according to claim 1, wherein each of the at least one storage area comprises an at least one master image back-up storage area for storing a baseline recovery image.

4. The apparatus according to claim 1 further comprising a temporary data storage area.

5. The apparatus according to claim 1, wherein each said recovery point is associated with one or more of the group consisting of: a name; a description; a time; a date.

6. The apparatus according to claim 1, wherein the number and size of said at least one recovery points are limited by available disk drive space.

7. The apparatus according to claim 1, further comprising a problem detecting module for verifying the existence and functionality of at least one entity, said entity belongs to the group consisting of: a device; a service; a program; a parameter.

8. The apparatus according to claim 1, further comprising a controller for initiating a disk drive recovery operation using a predetermined recovery point.

9. The apparatus according to claim 1, further comprising a device communicating with a disk drive via a communication path.

10. The apparatus according to claim 9 wherein the communication path is a personal computer interface bus.

11. A computer readable storage medium containing a set of instructions for a general purpose computer, the set of instructions comprising:
a backup component for generating an at least one recovery point for an at least one disk drive or an at least one partition of the at least one disk drive or an at least one part of the at least one disk drive.

12. The computer readable storage medium according to claim 11 further comprising a recovery component for recovering an at least one disk drive or an at least one partition of the at least one disk drive or an at least one part of the at least one disk drive to a state presented by a predetermined recovery point.

13. An apparatus for disk drive protection and recovery comprising:
a device module communicating bi-directionally with a disk drive of a computing platform via a communication path; and
a component for operating said disk drive protection and recovery apparatus.

14. The system according to claim 13 wherein said communication path is a personal computer interface bus.

15. The system according to claim 13, further comprising a driver module in direct bi-directional communication with said device module.

16. The apparatus according to claim 15, wherein said driver module includes an identification verification module.

17. The apparatus according to claim 13, further comprising:
an at least one storage area, for storing data for an at least one recovery point for the disk drive; and
a backup component for generating an at least one recovery point for an at least one disk drive or an at least one partition of the at least one disk drive or an at least one part of the at least one disk drive.

18. The apparatus according to claim 17 further comprising a recovery component for recovering the at least one disk drive or the at least one partition of the at least one disk drive or the at least one part of the at least one disk drive to a state presented by a predetermined recovery point.

19. The apparatus according to claim 17 wherein said recovery component is loaded to the memory of the computing platform during a boot operation.

20. The apparatus according to claim 13, wherein said device module further comprises: a buffer; a communication interface; a programmable device identifier, said programmable device identifier being in communications with said buffer; and flash memory, said flash memory in communications with said buffer, said buffer forwarding data to said communication interface, said communication interface in bidirectional communications with said disk drive.

21. The apparatus according to claim 20 wherein the communication interface is a bus interface.

22. The apparatus according to claim 13, wherein said device module is any of the following group: universal serial bus device; a personal computer interface device; a mobile phone; a disk on key; an authentication device; a flash read-only-memory; a disk on module.

23. An apparatus for disk drive protection and recovery comprising:
a device module communicating with an at least one disk drive via a bus;
a component for operating said disk drive protection and recovery apparatus;
an at least one storage area, for storing data for at least one for recovery point for the disk drive; and
a backup component for generating an at least one recovery point for the disk drive or an at least one partition of the at least one disk drive or for an at least one part of the at least one disk drive.

24. The apparatus according to claim 23 further comprising a recovery component for recovering the at least one disk drive or the at least one part of the disk drive or the at least one partition of the disk drive to a state at which a predetermined recovery point was generated.

25. A method for protection and recovery of a disk drive of a computing device, the method comprising the steps of:
initiating a boot sequence on said computing device;
verifying a protection or recovery apparatus is properly installed on said computing device; and
preventing further booting operations until an electronic identification key is introduced to said computing device.

26. A method for protection and recovery of an at least one hard disk drive of a computing device, the method comprising the steps of:
storing at least one recovery point for said at least one hard disk drive; and
restoring the at least one hard disk drive from the at least one stored recovery point.

27. The method of claim 26 wherein the at least one stored recovery point can be overwritten and stored again.

28. The method of claim 26 wherein the at least one stored recovery point is kept after the at least one hard disk drive was restored.

29. The method of claim 26 wherein the at least one stored recovery point is destroyed after the at least one hard disk drive was restored to the at least one recovery point.

30. The method of claim 26 wherein an at least one additional recovery point which was stored after the recovery point is destroyed after the at least one hard disk drive was restored to the at least one recovery point.

31. The method of claim 26 further comprising the steps of:
detecting at least one problem with the existence and functionality of at least one entity of the following group: a device; a service; a program, a parameter; and
activating the restoring step if a problem is detected in the at least one entity.

32. The method of claim 26 wherein the storing and restoring steps are performed separately by a user or by an administrator.

33. A method for protection or recovery of a disk drive of a computing device, the method comprising the steps of:
booting said computing device;
verifying a protection or recovery apparatus is properly installed;
preventing further booting operations until an electronic identification key is introduced to said computing device;
storing at least one recovery point for said disk drive; and
restoring the disk drive from the at least one stored recovery point.
